(19) United States
(12) Patent Application Publication
(10) Pub. No.: US 2009/0142185 A1
(43) Pub. Date: Jun. 4, 2009

(54) ADJUSTING RING FOR ADJUSTING THE BLADES OF THE VTG DISTRIBUTOR OF EXHAUST GAS TURBOCHARGERS

(75) Inventors: Holger Fath, Fussgoenheim (DE); Ralf Boning, Reiffelbach (DE); Dirk Frankenstein, Worms (DE)

Correspondence Address: BORGWARNER INC. C/O PATENT CENTRAL LLC, 1401 HOLLYWOOD BOULEVARD, HOLLYWOOD, FL, 33020-5237, US

(73) Assignee: BORG WARNER INC., Auburn Hills, MI (US)

(21) Appl. No.: 11/913,896

(22) PCT Filed: Mar. 10, 2006
(86) PCT No.: PCT/EP06/02233

§ 371 Date: Nov. 25, 2008

(30) Foreign Application Priority Data
May 13, 2005 (EP) 05010523.8

(51) Int. Cl. F01D 17/16; B23P 11/00

(52) U.S. Cl. 415/159; 29/889.22

(57) ABSTRACT

The invention relates to an adjusting ring (1) for adjusting the blades of the VTG distributor of exhaust gas turbochargers, comprising a bearing ring (2) and a lever engagement ring (3) connected to said bearing ring (2), the bearing ring (2) and lever engagement ring (3) being separately manufactured individual parts which are connected to each other by means of a separate connection device (4).

The invention relates to an adjusting ring for adjusting the blades of the VTG distributor of exhaust gas turbochargers.

The term “VTG distributor” is to be understood to mean an arrangement which serves to provide exhaust gas turbochargers with a variable turbine geometry. An adjusting ring of the type specified in the preamble of claim 1 serves to adjust said variable turbine geometry, which adjusting ring has a bearing ring for holding bearing bodies and a lever engagement ring. The lever engagement ring is provided with grooves into which the levers of the VTG blades engage.

Such known adjusting rings are formed as fully-cut components which are conventionally produced in turning or milling processes or combined working steps. For this purpose, the adjusting ring with its bearing ring and a lever engagement ring is formed as an integral part from a solid material. This is however a relatively time-consuming and expensive production method.

Casting a complete adjusting ring raw part with subsequent cutting machining also does not lead to significant cost advantages.

It is therefore an object of the present invention to create an adjusting ring of the type specified in the preamble of claim 1, which adjusting ring can be produced in a simple and cost-effective manner.

It is also an object of the invention to create a method for producing an adjusting ring of said type.

The achievement of said object is provided by means of the features of claim 1 and of claim 9.

According to the invention, the adjusting ring is produced from a plurality of separately produced individual parts, at least two separately produced individual parts, which are connected to one another by means of a suitable connecting device. Here, the individual parts can be produced completely by primary forming (fine casting or sintering), shaping (pressing) or separating methods, preferably punching, or require a small degree of cutting finishing such as turning or milling.

The individual parts can be composed of different materials which are adapted to the specific bearing function of the bearing ring or bearing section of the adjusting ring, and to the guidance of the blade levers of the lever engagement ring or lever engagement section.

There is also the advantage that the bearing ring and the lever engagement ring can be adapted to said functions in a simple manner in terms of their geometry. Targeted hardening of the surface according to the required properties is for example possible.

Subclaims 2 to 6 contain advantageous refinements of the adjusting ring according to the invention.

Claims 8 to 11 define a method according to the invention for producing an adjusting ring as explained above.

According to said claims, the bearing ring and the lever engagement ring are produced in each case in a separate production step as separate individual parts.

The two rings are thereafter connected to one another by means of a suitable connecting device.

In principle, all suitable cohesive or form-fitting connections can be considered as a connecting device.

In the method according to the invention, however, flanging or overturning processes and also welding or soldering are particularly preferred for connecting the bearing ring and the production ring.

In principle, a screw connection or a rivet connection would also be conceivable.

Further details, advantages and features of the invention can be gathered from the following description of an exemplary embodiment on the basis of the drawing, in which:

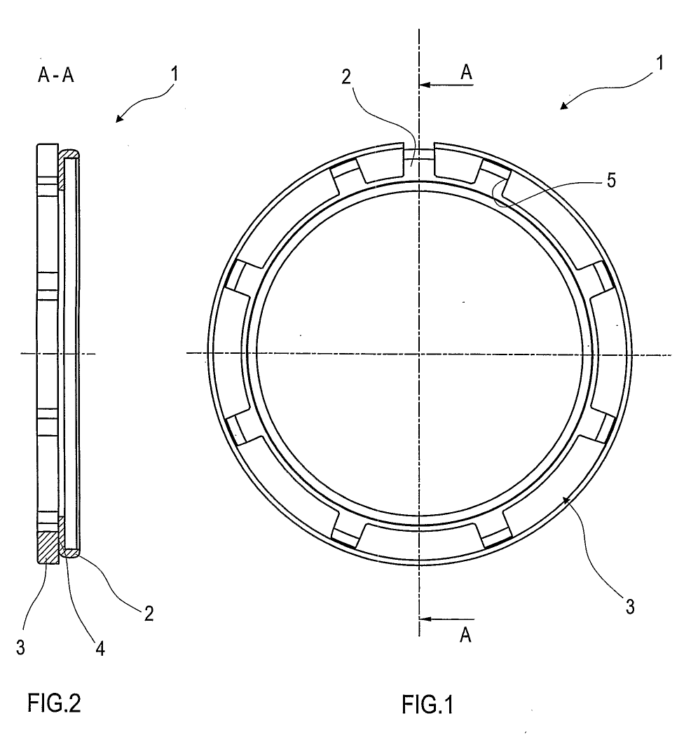

FIG. 1 shows a front view of an adjusting ring according to the invention, and

FIG. 2 shows a section illustration of the adjusting ring as per FIG. 1 along the line A-A in FIG. 1.

FIG. 1 illustrates an adjusting ring 1 according to the invention for adjusting the blades of a VTG distributor of exhaust gas turbochargers.

The adjusting ring 1 has a bearing ring 2 which is provided for guiding suitable bearing bodies (rolling bodies).

In addition, the adjusting ring 1 has a lever engagement ring 2 which has a plurality of grooves arranged on the periphery, one of which grooves is denoted by the reference symbol 5.

As shown in FIG. 1, the adjusting ring with its two components, the bearing ring and the lever engagement ring 3, is a circular component which is illustrated again in FIG. 2 along the section line A-A.

Here, FIG. 2 shows that the bearing ring 2 and the lever engagement ring 3, after their production as individual parts, are connected to one another by means of a connecting device 4 in order to form the adjusting ring 1 in its entirety. The connecting device 4 is shown here by the separating line between the bearing ring 2 and the lever engagement ring 3 and can be generated by means of one of the production methods explained in the introduction.

### LIST OF REFERENCE SYMBOLS

1 Adjusting ring
2 Bearing ring
3 Lever engagement ring
4 Connecting device
5 Groove

1-12. (canceled)

13. A method for producing an adjusting ring (1) for adjusting the blades of the VTG distributor of exhaust gas turbochargers, the method comprising:
producing a bearing ring (2) as a separate component;
producing a lever engagement ring (3) as a separate component in a separate production step from the producing of the bearing ring; and
connecting the bearing ring (2) to the lever engagement ring (3).

14. The method as claimed in claim 13, further comprising punching separate sheet metal parts to form at least in part at least one of the bearing ring (2) and the lever engagement ring (3).

15. The method as claimed in claim 13, further comprising sintering separate sheet metal parts to form at least in part at least one of the bearing ring (2) and the lever engagement ring (3).

16. The method as claimed in claim 13, further comprising forming a connection between the bearing ring (2) and the lever engagement ring (3) by welding or soldering.

17. The method as claimed in claim 13, wherein the bearing ring (2) and the lever engagement ring (3) are the same materials.

18. The method as claimed in claim 13, further comprising providing at least one of the bearing ring (2) and the lever engagement ring (3) with a geometry that provides a bearing function or a guidance function for the adjusting ring (1).

19. The method as claimed in claim 13, further comprising providing the bearing ring (2) as a sheet metal part.

20. The method as claimed in claim 13, further comprising providing the lever engagement ring (3) as a sheet metal part.

21. The method as claimed in claim 13, further comprising punching separate sheet metal parts to form at least in part both the bearing ring (2) and the lever engagement ring (3).

22. The method as claimed in claim 13, further comprising sintering separate sheet metal parts to form at least in part both the bearing ring (2) and the lever engagement ring (3).

23. An adjusting ring (1) for adjusting the blades of the VTG distributor of exhaust gas turbochargers, the adjusting ring (1) comprising:
a bearing ring (2);
a lever engagement ring (3) connected to the bearing ring (2); and
a connecting device (4), wherein the bearing ring (2) and the lever engagement ring (3) are individual parts which are connected to one another by the connecting device (4) that is an individual part.

24. The adjusting ring (1) as claimed in claim 23, wherein at least one of the bearing ring (2) and the lever engagement ring (3) has a geometry that provides a bearing function or a guidance function for the adjusting ring (1).

25. The adjusting ring (1) as claimed in claim 23, wherein the bearing ring (2) and the lever engagement ring (3) are the same materials.

26. The adjusting ring (1) as claimed in claim 23, wherein the connecting device (4) is formed as a flanged connection.

27. The adjusting ring (1) as claimed in claim 23, wherein the connecting device (4) is welded or soldered with the bearing ring (2) and the lever engagement ring (3).

28. A method for producing an adjusting ring (1) for adjusting the blades of the VTG distributor of exhaust gas turbochargers, the method comprising:
punching a first sheet metal part to form at least in part a bearing ring (2);
punching a second sheet metal part to form at least in part a lever engagement ring (3); and
connecting the bearing ring (2) to the lever engagement ring (3) using a separate connecting device (4) that is soldered or welded to the bearing ring (2) and the lever engagement ring (3).

29. The method as claimed in claim 28, wherein the bearing ring (2) and the lever engagement ring (3) are the same materials.

30. The method as claimed in claim 28, wherein the connecting device (4) is formed as a flanged connection.
